(19) United States
(12) Patent Application Publication
(10) Pub. No.: US 2017/0140129 A1
(43) Pub. Date: May 18, 2017

(54) METHOD AND SYSTEM FOR CARE & HOST

(71) Applicants: Robert C. Banasik, Columbus, OH (US); Marcus A. Banasik, Columbus, OH (US)

(72) Inventors: Robert C. Banasik, Columbus, OH (US); Marcus A. Banasik, Columbus, OH (US)

(21) Appl. No.: 15/354,580

(22) Filed: Nov. 17, 2016

Related U.S. Application Data
(60) Provisional application No. 62/256,395, filed on Nov. 17, 2015.

(51) Int. Cl. G06F 19/00

(52) U.S. Cl. CPC G06F 19/363; G06F 19/328; G06F 19/327

(57) ABSTRACT

A method or system is disclosed for assessing a level of care for a care guest and matching the care guest to at least one care host or to an assisted living place. The method includes steps of (a) assessing a suitable level of care for the care guest, by prompting the care guest to choose an answer from an array of possible answer choices to each question from a set of questions and assigning an answer score to each answer and compute an assessment score for the care guest; (b) assessing a care host by prompting the care host to select an answer from an array of possible answer choices to each question from a set of questions assigning an answer score to each answer and compute an assessment score for the care host; and (c) matching the care guest to at least one care host through evaluating the answer scores and assessment scores for the care guest and one or more care hosts. The questions are selected from a group consisting of bathing, hygiene, dressing, telephone use, snack preparation, eating, transfer, mobility, daily housekeeping, going to the bathroom, wellness, mental status, medications, and a means to getting medications.

### CROSS-REFERENCES TO RELATED APPLICATIONS

This application claims the benefits of U.S. Provisional Application 62,256,395 filed on Nov. 17, 2015. The contents of the provisional application are incorporated herein by reference.

### STATEMENT REGARDING FEDERALLY-SPONSORED RESEARCH AND DEVELOPMENT

(Not Applicable)

### REFERENCE TO AN APPENDIX

(Not Applicable)

### BACKGROUND OF THE INVENTION

This invention relates generally to the method of assessing and assisting in provision of care to seniors and/or disabled individuals.

Currently, half of the people over 70 are living alone and the number is increasing rapidly. The number of people of advanced age with care needs is increasing much faster than the resources that can be developed to meet the needs of these people. In other words, existing independent housing and/or care facilities cannot meet the upcoming needs of senior people and/or disabled individuals.

In addition, many seniors and/or disabled individuals would like to remain in the local community while obtaining suitable levels of support and care, preferably in a safe, secure, and independent environment. With increasing costs and inconvenience of nursing homes and/or hospitals, there is an increasing need or preference for such a care. However, it is very difficult to assess such needs due to uniqueness of individual needs, and ever changing standards established by various insurance and reimbursement systems. In addition, it is difficult to find or match suitable hosts to take care of such seniors or disabled individuals aside from the regulated places, such as nursing homes.

### BRIEF SUMMARY OF THE INVENTION

It would therefore be advantageous to provide an inexpensive, simple and robust method and system to accurately assess the levels of care needed for seniors and/or disabled individuals. It would further be advantageous to provide a method and system to identify suitable hosts to provide such care, and match and connect those in need and those wishing to help together.

The present invention provides methods and systems to allow for customers, such as seniors and/or disabled individuals, to assess their own level of care needed and find suitable care hosts to meet their care levels. As such, this invention allows seniors and/or disabled individuals to take control of their own care level assessment process before being placed in a high pressure situation at a senior care facility.

Many people of advanced ages (seniors or elderly) often live alone, causing their home sanctuary to be a solitary place with little or no socialization, resulting in irregularity in eating and administration of medications. Moreover, with less income, seniors often struggle to stay in their current homes and need to downsize to shed responsibilities of taking care of a home. With their needs for socialization, care from others, among others, there is an increasing need for seniors to find suitable care hosts to provide them with affordable housing and care.

On the other hand, there are many people who can be suitable care hosts for seniors. Such people usually like to help others, with available room(s) in their living space, would like to add to their income streams, and may have special abilities or skills to provide healthcare to suitable seniors.

Recognizing that those in need and those wishing to help are not readily in contact, the present invention includes methodology and easy-to-use applications/systems to make it possible to provide both with alternatives that keep seniors in the community and help those with “home to spare” open their homes to those in need while adding income and possibilities. Those who provide needs are called care hosts (can also be referred to as “CareShare Hosts” as shown in FIG. 4), while those who are in need of caring are called care guests (can also be referred to as “CareShare Guests” as shown in FIG. 4).

### BRIEF DESCRIPTION OF THE SEVERAL VIEWS OF THE DRAWINGS

FIG. 1 is a flow chart of one illustrative embodiment of a process matching a care host to a care guest. A care host is a person who wishes to provide care to a care guest, who is a person in need of care, such as a senior or disabled individual.

FIG. 2 is a flow chart of one illustrative embodiment of a process (or method/system) for assessing the level of care for a care guest.

FIG. 2a is a screen capture of a care guest's account according to the embodiment of the process for assessing the level of care needed for a care guest as illustrated in FIG. 2.

FIG. 3 is a flow chart of one illustrative embodiment of a process for assessing the levels of care that can be provided by a care host.

FIG. 4 is a flow chart of illustrative embodiment of a care assessment process to match a care guest to a care host through a website application.

### DETAILED DESCRIPTION OF THE INVENTION

The present invention is directed to a method and system for obtaining and assessing the level of needed care for an individual in need of suitable care, and matching the individual to a suitable care host. The individual in need of suitable care can be referred to as “care guest,” “careshare guest,” or “customer” (hereafter referred to as “care guest”), who can be an elderly (also called a senior), and/or a disabled individual. The care host refers to an individual or an institution or a company who can provide suitable levels of care to a care guest, who can be a homeowner, a nursing home or an assisted living place. This method provides, in one embodiment, an ongoing update of information content and sources while at the same time filtering out unnecessary information that is irrelevant to assessment of the care level to a care guest, resulting in more accurate assessment and more suitable matching between a care guest and a care host.

The processes and method in the present invention are developed over many years to address the issue to match those in need with those willing to provide a safe, secure and independent environment that meets the needs of the seniors. The questions, answer choices, and the answer scores as related to the answer choices in the assessment of the level of care for care guests are the results of distilling detailed patient information including, but not limited to the following:

(1) analysis of assessment related to patients' daily living activities;

(2) physical mobility and information derived from licensed therapy professionals;

(3) age and related demographic information; and

(4) social services assessments on both pre- and post admission to supervised living.

The assessment method was tested and adjusted to correlate the assessment data to results that reflect the ever changing standards established by the various insurance and reimbursement systems particular to the senior care industry. The method has been continually tested by matching the current input of care guests (the new patient or resident to the nursing homes) to suitable care hosts with appropriate living arrangements. The living arrangement of the care hosts for the care guests focuses on care requirements, supervision, and oversight necessary to maintain high level of independence of the care guests. The consistency of correlating the assessment data to the assessment results was verified to the expectations of third party providers. Recognizing every individual is unique, the present inventive method provides the ability to narrow and focus the decision making process to assure the highest possible degree of success.

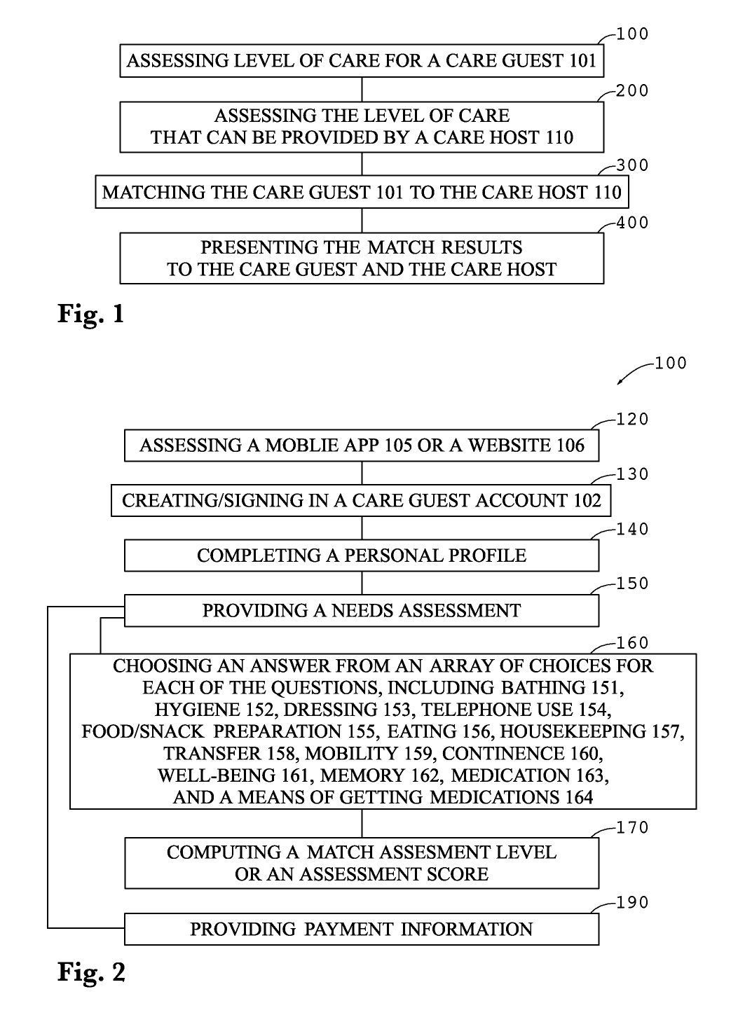

According to one embodiment of the present invention as shown by FIG. 1, the present method starts with the step 100 of assessing the level of needed care for a care guest 101, and then, match 300 the care guest 101 to a suitable care host 110. The care host's personal and location information is first obtained from an individual who is interested in being a care host, and such information is then assessed and matched to a suitable care guest 101. The assessment 200 of the care host 110 can be done simultaneously, before or after the assessment of a care guest 101. Then, the care guest's assessment results are evaluated and matched 200 to a suitable care host 110. The results of the matching are then sent to the care guest and care host respectively 400 through emails or other contact methods provided by the parties. The parties refer to the care guest and the care host. Should the parties are not satisfied with each other, or no match is found, a message is sent to the care guest that

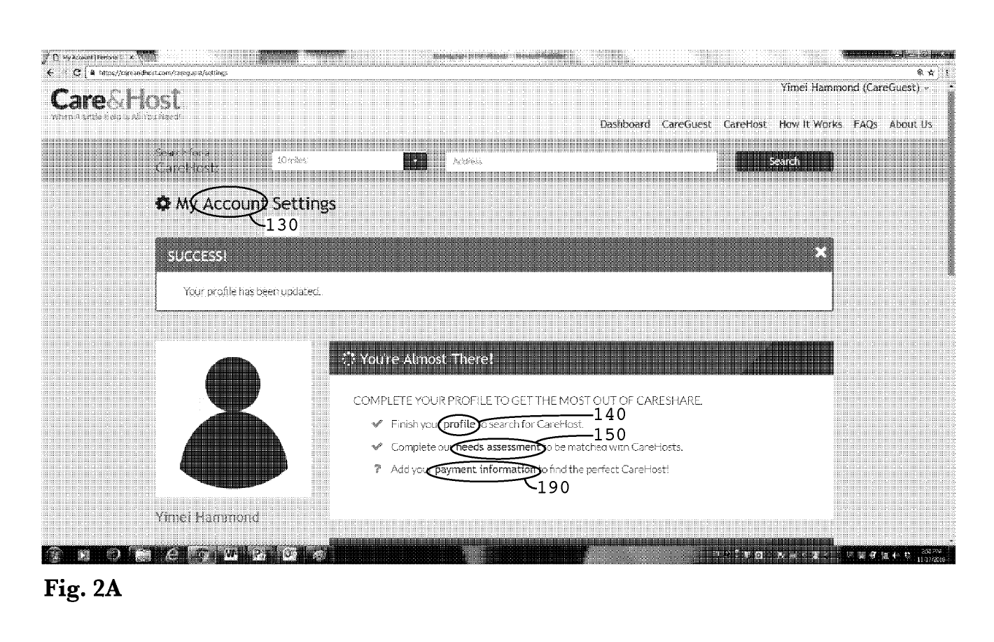

According to the present invention as shown by FIG. 2, a care guest's assessment process 100 starts with a step of creating a personal profile via a website 106 (www.careandhost.com) or a mobile application 105. To create this personal profile, the care guest 101 first either logs onto a mobile application on a mobile device (step 120), such as “care&host assessment survey” application, or gets on the www.careandhost.com webpage. Then, the care guest creates (step 130) a care guest account 102 by providing an email address and creating a suitable password for the account. Afterwards, the care guest is prompted automatically to complete his or her personal profile 140 or by clicking “your profile” button as shown in FIG. 2a. The personal profile 140 includes a care guest's address, age, sex, and contact information, such as emails, phone numbers. The care guest can also provide other information, such as personal interests or preferences, which can assist in finding a better match in a care host. The personal information can be edited as needed by the care guest.

The care guest is then prompted to complete “needs assessment” 150, which includes a set of questions targeted to assess a suitable level of needed care for the care guest. The questions or question categories (or categories) include bathing 151, hygiene 152, dressing 153, telephone use 154, food or snack preparation 155, eating 156, housekeeping 157, transfer of the care guest 158, mobility 159, continence 160, well-being 161, memory 162, medication 163, and a means for getting medication 164. The scores are then used to compute the match assessment level (the assessment score) 170. After finishing the needs assessment 150, the care guest is prompted to provide payment information 190.

The followings are answer choices for each of the questions:

Question 1: Bathing 151

| Answer | | |
|---|---|---|
| score | Answer Options or Choices | |
| 0 | □ | Independent - no assistance required in bathing. Uses |
| | | assistance/adaptive devices (shower stool, handrails. Etc). |
| | | May need occasional reminding. |
| 1 | □ | Preparation needed of bath water and supplies. |
| 2 | □ | Assistance needed to get in and out of shower. |
| 3 | □ | Only able to wash face and hands. |
| 4 | □ | Dependent - Total assistance required in preparation, |
| | | getting in and out shower, complete washing, and drying |
| | | of body. |

Question 2: Hygiene 152

| Answer | | |
|---|---|---|
| score | Answer Options or Choices | |
| 0 | □ | Independent - no assistance required. |
| 1 | □ | Minor assistance needed including: reminders to bathe, |
| | | shave, comb hair, clip nails, brush teeth, etc. |
| 2 | □ | Needs higher degree of assistance such as preparation |
| | | of grooming materials. |
| 3 | □ | Requires limited hands on assistance, such as steadying |
| | | of the hands because of physical impairment. |
| 4 | □ | Dependent - Total assistance required in washing face, |
| | | combing hair, shaving, clipping nails, brushing teeth, etc. |

Question 3: Dressing 153

| Answer | | |
|---|---|---|
| score | Answer Options or Choices | |
| 0 | □ | Independent - no assistance required. |
| 1 | □ | Needs occasional help with zippers, buttons, tying |
| | | shoelaces, etc. |
| 2 | □ | Needs structuring - daily assistance with what to wear |
| | | as well as help with zippers and buttons. |
| 3 | □ | Moderate assistance - puts clothing on or takes |
| | | clothing off with assistance or needs help with |
| | | prosthesis if applicable. |
| 4 | □ | Fully dependent - can offer no assistance. Requires |
| | | someone to completely dress. |

Question 4: Telephone Use 154

| Answer | | |
|---|---|---|
| score | Answer Options or Choices | |
| 0 | □ | Independent-no assistance needed to make and receive |
| | | calls. |
| 1 | □ | Assistance needed to initiate calls; able to receive calls |
| | | on own. |
| 2 | □ | Care guest only able to dial a few numbers from |
| | | memory. |
| 3 | □ | Care guest is only able to receive calls. |
| 4 | □ | Staff must make and receive call for the care guest. |

Question 5: Food or Snack Preparation 155

| Answer | | |
|---|---|---|
| score | Answer Options or Choices | |
| 0 | □ | Independent-care guest can prepare snack/food and |
| | | clean up |
| 1 | □ | Prepare food or snack on own, but may need prompting |
| | | and help with selection and clean up. |
| 2 | □ | Need assistance with kitchen equipment (such as |
| | | microwave). |
| 3 | □ | Can only prepare cold snack or food, cannot use |
| | | kitchen equipment alone. |
| 4 | □ | Snacks or food must be prepared, completed and served |
| | | by staff for the care guest. |

Question 6: Eating 156

| Answer | | |
|---|---|---|
| score | Answer Options or Choices | |
| 0 | □ | Independent-no assistance needed. |
| 1 | □ | Assistance needed with opening cartons, packets, |
| | | crackers, condiments, etc. |
| 2 | □ | Assistance needed in cutting foods, such as meats. |
| 3 | □ | Moderate assistance-prompting required or cannot |
| | | hold utensils or cup steadily without staff intervention |
| | | or help. |
| 4 | □ | Dependent - hands on assistance needed for all aspects of |
| | | eating. |

Question 7: Housekeeping (or Daily Housekeeping) 157

| Answer | | |
|---|---|---|
| score | Answer Options or Choices | |
| 0 | □ | Independent-no assistance needed to keep apartment |
| | | neat and tidy. |
| 1 | □ | Can perform light tasks such as dishwashing and bed |
| | | making. |
| 2 | □ | Very light tasks, cannot maintain acceptable level of |
| | | cleanliness for health and safety. |
| 3 | □ | Cannot maintain orderliness of personal items, such as |
| | | newspapers, foodstuffs, or personal items. |
| 4 | □ | All tasks associated with daily tidying must be completed |
| | | by staff. |

Question 8: Transfer (referring to the transfer of the care guest) 158

| Answer | | |
|---|---|---|
| score | Answer Options or Choices | |
| 0 | □ | Independent-no assistance needed. Care guest may |
| | | use assistive device safely. |
| 1 | □ | Standby assist-care guest is unsteady at times and |
| | | requires staff to be present to oversee transfer for |
| | | safety. |
| 2 | □ | Contact Guard-care guest able to transfer self with |
| | | limited hand on assistance from staff. |
| 3 | □ | Extensive-care guest needs hands on assistance with |
| | | staff member lifting. |
| 4 | □ | Dependent-care guest unable to transfer self. Staff |
| | | must provide hands on extensive assistance. |

Question 9: Mobility 159

| Answer | | |
|---|---|---|
| score | Answer Options or Choices | |
| 0 | □ | Independent-needs no assistance. May use assistive |
| | | device. |
| 1 | □ | Supervised-care guest ambulates with staff member |
| | | present to ensure safety. |
| 2 | □ | Contact Guard-care guest ambulates with hands on |
| | | assistance from staff. |
| 3 | □ | Wheelchair dependent-care guest needs assistance into |
| | | wheelchair, but can propel wheelchair safely with |
| | | direction and cueing from staff. |
| 4 | □ | Dependent-care guest unable to propel their own |
| | | wheelchair. Task must be performed by staff. |

Question 10: Continence (or Going to the Bathroom) 160

| Answer | | |
|---|---|---|
| score | Answer Options or Choices | |
| 0 | □ | Complete continent. |
| 1 | □ | Occasionally incontinent, but under control with |
| | | medications and MD or doctor supervision. |
| 2 | □ | Minor assistance needed such as reminders and assistance |
| | | to and from a bathroom. |
| 3 | □ | Substantial assistance required - must be reminded, taken |
| | | to a bathroom and needs help with cleaning. |
| 6 | □ | Totally incontinent. Total assistance needed from the |
| | | care host. |

Question 11: Well-Being 161

| Answer | | |
|---|---|---|
| score | Answer Options or Choices | |
| 0 | □ | In good general overall health with no serious |
| | | difficulties preventing independent living. |
| 1 | □ | Stable chronic conditions. |
| 2 | □ | Unstable chronic conditions where flare ups may occur |
| | | including but not limited to the followings: diabetics, |
| | | CHF, shortness of breath, edema of BLE, and seizures. |
| 3 | □ | Acute or life threatening conditions with some hope of |
| | | recovery (including heart attacks, some kinds of cancer, |
| | | and mild strokes). |
| 4 | □ | Terminal illness - state of dying, comfort, or pain |
| | | reduction. |

Question 12: Memory (also called Mental Status) 162

| Answer | | |
|---|---|---|
| score | Answer Options or Choices | |
| 0 | □ | Oriented to person, time, and place but may have some |
| | | occasional forgetfulness |
| 1 | □ | Mild impairment-some confusion, difficulty |
| | | remembering details, and may need guidance. |
| 2 | □ | Moderate impairment-memory loss, especially current |
| | | events. May be anxious, agitated at times or depressed. |
| 3 | □ | Heavy impairment in all areas, prone to wandering, |
| | | unable to remember personal information, and confused |
| | | as to time and place. |
| 6 | □ | Severe impairment affecting all areas of judgment. |

Question 13: Medication 163

| Answer | | |
|---|---|---|
| score | Answer Options or Choices | |
| 0 | □ | Independent medications can be provided by self, a |
| | | caregiver, or a pharmacy dispensary system. |
| 4 | □ | Dependent-medications must be administered by a |
| | | healthcare professional, such as home health care |
| | | provider, nurse, doctors, etc. |

Question 14: If needed, can the care guest have the means to provide medication? 164

| Answer score | Answer Options or Choices |
|---|---|
| n/a | □ Yes |
| n/a | □ No. |

Except for the question of medication, all questions have five choices, going from independent to dependent, separating into five levels, which roughly correspond to independent, moderately independent, more assistance needed, moderately dependent, and totally dependent.

Based on the care guest's choices, answer scores are evaluated and assessed 150. The scores for hygiene 152, dressing 153, telephone use 154, food preparation 155, eating 156, housekeeping 157, transfer 158, and mobility 159 are tallied up to an assessment score (also called “the CareShare Guest Score” or “the Total Score” or “the care guest score” or “the care guest's assessment score”), also called the step of computing the match assessment level or the CareShare Guest Score 170. The care guest's assessment score does not include answer scores from the questions of memory 162, continence 160, and bathing 151.

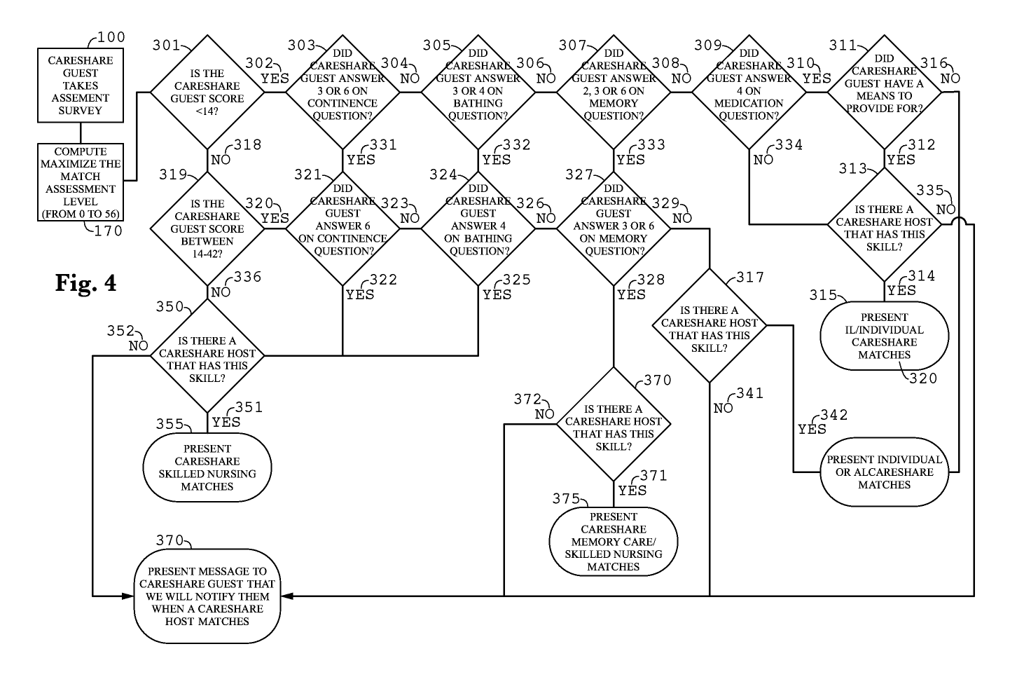

The level of care assessment for the care guest is then assessed as shown in FIG. 4. After the CareShare Guest (also called the care guest) takes the assessment survey 100, the Match Assessment Level is computed (step 170).

According to an embodiment of the present invention as illustrated in FIG. 1, after obtaining the results from a care guest's assessment process as shown in FIG. 2, assessments for care hosts are made (step 200). Step 200 of assessing care hosts can be performed prior to, simultaneously with, or after the step of assessing the level of care for a care guest (step 100). The positioning of step 200 in FIG. 1 is for illustrative purposes only. A care host's assessment process 200 starts with a step of creating a personal profile via a website 206 (www.care&host.com) or a mobile application 205. To create this personal profile, the care host 110 either logs onto a mobile application on a mobile device (step 220), such as the “care&host assessment survey” mobile application, or gets on the www.careandhost.com webpage. Then, the care host creates (step 230) a care host account 202 by providing an email address and creating a suitable password for the account. Afterwards, the care host is prompted automatically to complete his or her personal profile 240 or by clicking “your profile” button. The personal profile 240 includes a care host's address, age, sex, and contact information, such as emails, phone numbers. The care host can also provide other information, such as personal interests or preferences, which can assist in finding a better match in a care host. The personal information can be edited as needed by the care host.

The care host is then prompted to complete “location information” 250, which includes a set of questions targeted to assess the level of needed care that can be provided by the care host. The questions or question categories (or categories) include bathing 251, hygiene 252, dressing 253, telephone use 254, food or snack preparation 255, eating 256, housekeeping 257, transfer (of the care guest) 258, mobility 259, continence 260, well-being 261, memory 262, medication 263, and a means of getting medication 264. The scores are then used to compute the match assessment level (the assessment score) 270 for the care host. Within the location information, living amenities provided by the care host are also inquired as to whether one or more are provided, such as kitchenette, wireless internet, washer & dryer, elevator, Cable TV, exercise equipment, hot tub, smoke detector, central air conditioning, fire extinguisher, en-suite bathroom, furnished, free parking, wheelchair accessible, pets allowed, pool, first aid kit, bedding & towels provided, buzz/intercom, smoking allowed, etc. Other information is also inquired as to the price of the care and the starting date. After finishing the location information 250, the care host is prompted to provide payment information 290.

The followings are answer choices for each of the questions for the care host in step 260:

Question 1 for the care host: Bathing 251

| Answer score | Answer Options or Choices |
|---|---|
| 0 | □ Independent—no assistance required in bathing. |
| | Uses assistance/adaptive devices (shower stool, |
| | handrails. Etc). May need occasional reminding. |
| 1 | □ Preparation needed of bath water and supplies. |
| 2 | □ Assistance needed to get in and out of shower. |
| 3 | □ Only able to wash face and hands. |
| 4 | □ Dependent—Total assistance required in preparation, |
| | getting in and out shower, complete washing, |
| | and drying of body. |

Question 2 for the care host: Hygiene 252

| Answer score | Answer Options or Choices |
|---|---|
| 0 | □ Independent—no assistance required. |
| 1 | □ Minor assistance needed including: reminders to bathe, |
| | shave, comb hair, clip nails, brush teeth, etc. |
| 2 | □ Needs higher degree of assistance such as preparation |
| | of grooming materials. |
| 3 | □ Requires limited hands on assistance, such as steadying |
| | of the hands because of physical impairment. |
| 4 | □ Dependent—Total assistance required in washing face, |
| | combing hair, shaving, clipping nails, brushing teeth, etc. |

Question 3 for the care host: Dressing 253

| Answer score | Answer Options or Choices |
|---|---|
| 0 | □ Independent—no assistance required. |
| 1 | □ Needs occasional help with zippers, buttons, |
| | tying shoelaces, etc. |
| 2 | □ Needs structuring—daily assistance with what |
| | to wear as well as help with zippers and buttons. |
| 3 | □ Moderate assistance—puts clothing on or takes |
| | clothing off with assistance or needs help with |
| | prosthesis if applicable. |
| 4 | □ Fully dependent—can offer no assistance. |
| | Requires someone to completely dress. |

Question 4 for the care host: Telephone Use 254

| Answer score | Answer Options or Choices |
|---|---|
| 0 | □ Independent—no assistance needed to make |
| | and receive calls. |
| 1 | □ Assistance needed to initiate calls; able to |
| | receive calls on own. |
| 2 | □ Care guest only able to dial a few numbers |
| | from memory. |
| 3 | □ Care guest is only able to receive calls. |
| 4 | □ Staff must make and/or receive (or accept) |
| | calls for the care guest. |

Question 5 for the care host: Food or Snack Preparation 255

| Answer score | Answer Options or Choices |
|---|---|
| 0 | □ Independent—care guest can prepare snack/ |
| | food and clean up |
| 1 | □ Prepare food or snack on own, but may need |
| | prompting and help with selection and clean up. |
| 2 | □ Need assistance with kitchen equipment (such |
| | as microwave). |
| 3 | □ Can only prepare cold snack or food, cannot use |
| | kitchen equipment alone. |
| 4 | □ Snacks or food must be prepared, completed and |
| | served by staff for the care guest. |

Question 6 for the care host: Eating 256

| Answer score | Answer Options or Choices |
|---|---|
| 0 | □ Independent—no assistance needed. |
| 1 | □ Assistance needed with opening cartons, packets, |
| | crackers, condiments, etc. |
| 2 | □ Assistance needed in cutting foods, such as meats. |
| 3 | □ Moderate assistance—prompting required or cannot hold |
| | utensils or cup steadily without staff intervention or help. |
| 4 | □ Dependent—hands on assistance needed for all |
| | aspects of eating. |

Question 7 for the care host: Housekeeping (or Daily Housekeeping) 257

| Answer score | Answer Options or Choices |
|---|---|
| 0 | □ Independent—no assistance needed to keep apartment |
| | neat and tidy. |
| 1 | □ Can perform light tasks such as dishwashing and bed |
| | making. |
| 2 | □ Very light tasks, cannot maintain acceptable level of |
| | leanliness for health and safety. |
| 3 | □ Cannot maintain orderliness of personal items, such as |
| | newspapers, foodstuffs, or personal items. |
| 4 | □ All tasks associated with daily tidying must be |
| | completed by staff. |

Question 8 for the care host: Transfer (referring to the transfer of the care guest) 258

| Answer score | Answer Options or Choices |
|---|---|
| 0 | □ Independent—no assistance needed. Care guest |
| | may use assistive device safely. |
| 1 | □ Standby assist—care guest is unsteady at times and |
| | requires staff to be present to oversee transfer for safety. |
| 2 | □ Contact Guard—care guest able to transfer self with |
| | limited hand on assistance from staff. |
| 3 | □ Extensive—care guest needs hands on assistance |
| | with staff member lifting. |
| 4 | □ Dependent—care guest unable to transfer self. Staff |
| | must provide hands on extensive assistance. |

Question 9 for the care host: Mobility 259

| Answer score | Answer Options or Choices |
|---|---|
| 0 | □ Independent—needs no assistance. May use assistive |
| | device. |
| 1 | □ Supervised—care guest ambulates with staff member |
| | present to ensure safety. |
| 2 | □ Contact Guard—care guest ambulates with hands on |
| | assistance from staff. |
| 3 | □ Wheelchair dependent—care guest needs assistance |
| | into wheelchair, but can propel wheelchair |
| | safely with direction and cueing from staff. |
| 4 | □ Dependent—care guest unable to propel their own |
| | wheelchair. Task must be performed by staff. |

Question 10 for the care host: Continence (or Going to the Bathroom) 260

| Answer score | Answer Options or Choices |
|---|---|
| 0 | □ Complete continent. |
| 1 | □ Occasionally incontinent, but under control with |
| | medications and MD or doctor supervision. |
| 2 | □ Minor assistance needed such as reminders and |
| | assistance to and from a bathroom. |
| 3 | □ Substantial assistance required—must be reminded, |
| | taken to a bathroom and needs help with cleaning. |
| 6 | □ Totally incontinent. Total assistance needed from |
| | the care host. |

Question 11 for the care host: Well-Being 261

| Answer score | Answer Options or Choices |
|---|---|
| 0 | □ In good general overall health with no serious |
| | difficulties preventing independent living. |
| 1 | □ Stable chronic conditions. |
| 2 | □ Unstable chronic conditions where flare ups may occur |
| | including but not limited to the followings: diabetics, CHF, |
| | shortness of breath, edema of BLE, and seizures. |
| 3 | □ Acute or life threatening conditions with some hope of |
| | recovery (including heart attacks, some kinds of cancer, |
| | and mild strokes). |
| 4 | □ Terminal illness—state of dying, comfort, or pain |
| | reduction. |

Question 12 for the care host: Memory (also called Mental Status) 262

| Answer score | Answer Options or Choices |
|---|---|
| 0 | □ Oriented to person, time, and place but may have |
| | some occasional forgetfulness |
| 1 | □ Mild impairment—some confusion, difficulty |
| | remembering details, and may need guidance. |
| 2 | □ Moderate impairment—memory loss, especially current |
| | events. May be anxious, agitated at times or depressed. |
| 3 | □ Heavy impairment in all areas, prone to wandering, |
| | unable to remember personal information, and confused |
| | as to time and place. |
| 6 | □ Severe impairment affecting all areas ot judgment, |

Question 13 for the care host: Medication 263

| Answer score | Answer Options or Choices |
|---|---|
| 0 | □ Independent medications can be provided by self, a |
| | caregiver, or a pharmacy dispensary system. |
| 4 | □ Dependent—medications must be administered by a |
| | healthcare professional, such as home health care |
| | provider, nurse, doctors, etc. |

Question 14 for the care host: If needed, can the care guest have the means to provide medication? 264

| Answer score | Answer Options or Choices |
|---|---|
| n/a | □ Yes |
| n/a | □ No. |

Except for the question of medication, all questions have five choices, going from independent to dependent, separating into five levels, which roughly correspond to independent, moderately independent, more assistance needed, moderately dependent, and totally dependent.

Based on the care host's choices, answer scores are evaluated and assessed 250. The answer scores are tallied up to an assessment score (also called “the CareShare host Score” or “the care host's assessment score” or “the care host score”), also called the step of computing the match assessment level or the CareShare Host Score 270. The care host's assessment score does not include answer scores from the questions of memory 162, continence 160, and bathing 151.

After assessing the level of care that can be provided by one or more care hosts, the needs of the care guests are matched to suitable care hosts as shown in FIGS. 1 and 4. If the care guest's assessment score from the care guest's assessment process as shown in FIG. 2 is within the range of 0-6, it indicates that the care guest requires an independent care hosts or can be without any care host, except that the choices in the categories or questions of bathing, continence, memory, and medication may cause the level of the care be changed, and as such, the care guest may require care hosts with relevant specialized skills. For example, even if the care guest's assessment score is 0, the care host with specialized skill is needed for the category of bathing with an answer score of 3 or 4, the category of continence with an answer score of 3 or 6, the category of memory with an answer score of 2, 3, or 6, and/or the category of medication with an answer score of 4. With these exceptions, if the medication must be administered by a healthcare professional, then the answer choice to the follow-up question 14 is determinative on whether the care host needs be skilled in nursing or the care host should be an assistant living company or place or a qualified nursing home.

The next step is to assess whether the CareShare Score is less than 14 (step 301). If the answer is yes to the CareShare Score being less than 14 (step 302), the assess process proceeds to the step 303 of checking whether the care guest's answer score on the continence question is 3 or 6. If the answer score for the continence question is not 3 or 6 (which means it is 0, 1, or 2) 304, the process continues to examine whether the answer score on the bathing question is 2, 3, or 6 (step 305). The answer is no (step 306), it means the answer score to the bathing question is 0 or 1, the process continues to the step 307 of examining whether the answer score on the memory question has a score or answer of 2, 3, or 6. If the answer is no (step 308), it means the answer score for the memory question is 0 or 1, which prompts the process to the step 309 of examining whether the answer score for the medication question is 4.

If the answer score is 4 for the medication question (step 310), it means the care guest needs to have the medication be administered by a healthcare provider (a care giver). It then continues to the step 311 of whether the care guest has a means to provide for the medication. If the answer to step 311 inquiry is yes (step 312), the process proceeds to find a care host (also called “CareShare Host”) who has the skill of providing the medication to the care guest (step 313). Once the care host 110 with the skill is found (step 314), there is a CareShare Match 320 (can also be referred to a care match 320 or a match 320), which is presented to the care guest 101 via email or other contact avenues (step 315). On the other hand, if the answer to the step 311 is no (step 316), which means that the care guest does not have a means to provide the medication, the process proceeds to find a care host with the ability to provide medication (the step 317 of finding out whether there is a care host that has this Skill). Such a care host is likely to be an assisted living place or a nursing home. If the answer to step 317 inquiry is no and there is no suitable care host to provide medication (step 341), a message will be sent to the care guest, stating that he or she will be notified when a suitable care host is found (step 360). If the answer to step 317 inquiry is yes and one or more care hosts with suitable skills are found (step 342), the matching results will be sent to the care guest and the care host respectively (step 345).

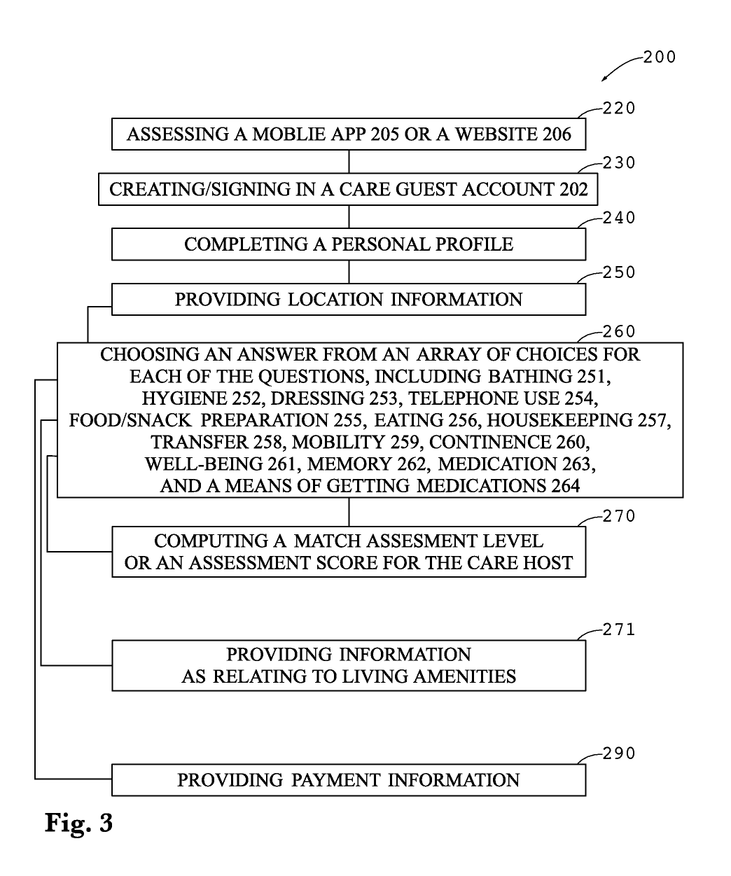

If the answer is no (step 334) to step 309 inquiry of whether medication requires administration by a healthcare professional, it means that the care guest can safely self-medicate. The process can then proceed to find a care host with suitable skills (step 313) based on the information and results of the care host assessment process 200 as shown in FIG. 3. Once a suitable care host is found and a match 320 is made (step 314), the matching results will be sent to the care guest and the care host respectively (step 315). On the other hand, if no suitable care host is found (step 335), a message will be sent to the care guest that he or she will be notified once a suitable care host is found (step 360).

If the answer is no to step 301 inquiry of whether the care guest assessment score is less 14 (step 318), it means that the assessment score is more 14, and the process continues to step 319 of finding out whether the care guest assessment score is in the range of 14 to 42. If the answer is yes (step 320) to step 319 inquiry, the process continues to evaluate whether the care guest answer score on the continence question is 6 (step 321). If the answer is yes (step 322), which means that the care guest is totally dependent on others to go to bathroom, then the process continues to the step 350 of whether the care host has the skill of providing the service. If the care host has the skill (step 351), a match 320 is found, and the match result is presented to the care guest and the care host respectively (step 355). On the other hand, if there is no suitable care host with such skills (step 352), a message is sent to the care guest that they will be notified when a matching care host is found (step 360).

If the answer is no (step 323) to step 321 of evaluating whether the care guest answer score to the continence question is 6, this means that the answer score is 3 and the care guest requires substantial assistance in going to the bathroom (step 323). The answer score is 3 in step 323 because this step 321 is after or within the constrain of step 331 of finding the care guest answer score to the continence question is 3 or 6 (please see the step 303), meaning the care guest requires either substantial assistance (an answer score of 3) or complete assistance (an answer score of 6) in going to the bathroom. After eliminating the answer of complete dependence in continence, the care guest is left with the need of substantial assistance to the continence question (an answer score of 3). The process continues to the step 324 of whether the care guest answer score on the bathing question is 4, that is, whether the care guest is totally dependent on others to bath him or her. If the answer is yes (step 325), the care guest is completely dependent on others to bath him or her, the process proceeds to check whether there is a care host with such skills (step 350). If a care host with such skills is found (step 351), a match 320 is made, and the matching result is sent to the care guest and the care host respectively (step 355). On the other hand, if no suitable care host is found (step 352), a message is sent to the care guest that they will be notified when a suitable care host is found (step 360).

If the answer is no (step 326) to step 324 of evaluating whether the care guest answer score to the bathing question of being 4, the answer score to the bathing question is 3, and the care guest is substantially dependent on others to bath him or her. The answer score is 3 in step 326 because this step 324 is after or within the constrain of the step 332 of finding the care guest answer score to the bathing question is 3 or 4 (please see the step 305), meaning the care guest requires either substantial assistance (an answer score of 3) or complete assistance (an answer score of 4) to bath himself or herself. After eliminating the answer of complete dependence in bathing (an answer score of 4), the care guest is left with the need of substantial assistance to the bath question (an answer score of 3)—step 326.

The process continues to the step 327 of whether the care guest answer score on the memory question is 3 or 6, that is, whether the care guest has a heavy memory impairment (an answer score of 3) or a severe memory impairment (an answer score of 6). Step 327 is after or within the constraints of the step 333 of finding the care guest's answer score to the memory question being 2, 3, or 6, meaning the care guest has a moderate (an answer score of 2) to severe memory impairment (an answer score of 6). If the answer is yes (step 328) to the step 327, the care guest has a heavy (an answer score of 3) to severe memory impairment (an answer score of 6), the process proceeds to check whether there is a care host with such skills for memory care (step 370) based on the information and results from the care host evaluation process 200 as shown by FIG. 3. If a care host with such skills is found (step 371), a match 320 is made, and the matching result is sent to the care guest and the care host respectively (step 375). On the other hand, if no suitable care host is found (step 372), a message is sent to the care guest that he or she will be notified when a suitable care host is found (step 360).

If the answer is no (step 329) to the inquiry in step 327 of whether the care guest's answer score to the memory question is 3 or 6, the care guest's answer score in this question is 2 based on the premise of step 333—the care guest's answer score is 2, 3, or 6. This means, the care guest in step 329 has a mild memory impairment, which requires a care host with skills to take care of such mild memory impairment (step 317). If a match 320 is found, the matching results will be sent to the care guest and the care host respectively (step 345).

Going back to step 319 of whether the care guest score is within the range of 14-42, if the answer is no to step 319 inquiry (step 336), then the care guest's assessment score is above 42 because step 319 is within the constraint of step 318 of the care guest's assessment score being 14 or above. The process then proceeds to step 350 of checking if there is at least one care host that has the required skills. If a suitable care host is found and a match is made (step 351), the matching results will be sent to the care guest and the care host respectively (step 355). If no suitable care host is found (step 352), a message will be sent to the care guest that he or she will be notified once a suitable care host is found (step 360). More than one suitable care host can be found in the matching process.

After matching a care guest with a suitable care host, additional screenings can be conducted, such as appropriate background check for the care guest and the care host. Such services can be done through a third party.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims. It also should be understood that the drawings are for illustration only. The present invention may be implemented using different computer languages, platforms, mobile applications, mobile devices, networks, and structures in keeping with the spirit or essential attributes of the invention, as described in the appended claims and in the specification.

1. A method for assessing a suitable level of care for a care guest and matching the careguest to at least one care host, comprising steps of:
a. assessing a level of care for the care guest, comprising:
i. prompting the care guest to choose an answer from an array of answer choices to each question from a set of questions, wherein the questions are selected from a group consisting of bathing, hygiene, dressing, telephone use, snack preparation, eating, transfer, mobility, daily housekeeping, going to the bathroom, wellness, mental status, medications, and a means to getting medications; and
ii. assigning an answer score to each answer and compute a care guest's assessment score;
b. assessing a level of care provided by a care host, comprising
i. prompting the care host to select an answer from an array of answer choices to each question from a set of questions, wherein the questions are selected from a group consisting of bathing, hygiene, dressing, telephone use, snack preparation, eating, transfer, mobility, daily housekeeping, going to the bathroom, wellness, mental status, medications, and a means of getting medications; and
ii. assigning an answer score to each answer and compute a care host's assessment score; and
c. matching the care guest to at least one care host based on the care guest's assessment score, the care host's assessment score and the answer scores to the questions of bathing, continence, memory and medication.

2. The method according to claim 1, wherein the assessment score is larger than 42, the care host is matched to at least one care host with skilled nursing capabilities.

3. The method according to claim 1, wherein the answer choices for questions of bathing, hygiene, dressing, telephone use, snack preparation, eating, transfer, mobility, daily housekeeping, going to the bathroom, wellness, and mental status include five levels, which roughly correspond to independent, moderately independent, more assistance needed, moderately dependent, and totally dependent.

4. The method according to claim 1, the answer choices to the medication question include independent—loved one can safely self-medicate, and dependent—medications and treatments must be administered by a licensed or suitable care giver.

5. The method according to claim 1, wherein a score selected from a group consisting of 0, 1, 2, 3, and 4 is assigned to each of the answer choices for the questions of bathing, hygiene, dressing, telephone use, snack preparation, eating, transfer, mobility, daily housekeeping, wellness; wherein a score selected from a group consisting of 0, 1, 2, 3, and 6 is assigned to each of the answer choices for the questions of continence, memory; wherein a score of 0 or 4 is assigned to each of the answer choices for the question of medication.

6. The method according to claim 1, wherein if no suitable care host is found, a message will be sent to the care guest that he or she will be notified once a care host is found, or that the care host is a nursing home or an assisted living place.
